(19) United States
(12) Patent Application Publication
(10) Pub. No.: US 2004/0104150 A1
(43) Pub. Date: Jun. 3, 2004

(54) Process for moving highly viscous residues deriving from oil processing

(75) Inventors: Armando Marcotullio, S. Donato Milanese (IT); Enrico Borgarello, Merlino (IT)

Correspondence Address: OBLON, SPIVAK, MCCLELLAND, MAIER & NEUSTADT, P.C., 1940 DUKE STREET, ALEXANDRIA, VA, 22314, US

(73) Assignee: ENITECNOLOGIE S.p.A., SAN DONATO MILANESE (IT)

(21) Appl. No.: 10/722,411

(22) Filed: Nov. 28, 2003

Related U.S. Application Data
(63) Continuation of application No. 10/277,105, filed on Oct. 22, 2002, now abandoned.
(63) Continuation of application No. 09/676,991, filed on Oct. 2, 2000, now abandoned.

(30) Foreign Application Priority Data
Oct. 8, 1999 (IT) MI99A 002104

(51) Int. Cl. F17D 1/17; F17D 1/18

(52) U.S. Cl. 208/370

(57) ABSTRACT

Process for recovering and moving refinery tar by the formation of oil in water dispersions of the above tar, the above dispersions having a water content of at least 20% by weight, and the dispersing agent being selected from salts of alkaline metals and ammonium, and relative mixtures, of the condensates of naphthalenesulfonic acid with formaldehyde, which comprises:

a) fluidification of the tar by heating to a temperature at least equal to its softening point;

b) mixing the tar thus fluidified with the desired quantity of water and dispersing agent until an oil in water dispersion is formed;

c) recovery and moving of the tar in the form of the oil in water dispersion formed in step (b).

The present invention relates to a process for moving oil residues (tar) having a softening point higher than 80° C.

More specifically, the present invention relates to a process for moving oil tar by means of the formation of aqueous dispersions, in the presence of particular dispersing agents, of the above tar.

The term “oil tar” refers to oil residues having a softening point higher than 80° C., usually higher than 100° C.

Typical examples of this oil tar are vacuum distillation residues of crude oils or of other oil fractions (for example of the distillation residue at atmospheric pressure), visbreaking residues.

At present, the above tar is moved and recovered by means of dilution with lighter hydrocarbon fractions until gas oils are obtained.

This process has the obvious disadvantage of having to use enormous quantities of hydrocarbon fractions with a higher value to obtain a lower-quality product.

Patent literature describes various processes for moving heavy crude oils or viscous oil fractions, which, however, as far as the properties are concerned, are not comparable to refinery tar.

One of the most widely studied methods for moving heavy crude oils consists in the formation of oil-in-water (O/W) emulsions, in which the external phase (water) is less viscous than the internal phase (oil). These emulsions, prepared by mixing, under stirring, water, emulsifying agent and oil, can be easily moved. As well as having a low viscosity, these emulsions must also have a certain stability, i.e. they must not separate into two phases when being transported and during their possible storage. In addition, the emulsifying additives must allow the formation of emulsions with a high-content of the oil phase. Regardless of these characteristics, a fundamental requisite for the use of this technique consists in the low cost of the emulsifying agents.

The emulsifying agents proposed in patent literature do not satisfy these requisites.

For example, U.S. Pat. No. 4,246,920, U.S. Pat. No. 4,285,356, U.S. Pat. No. 25 4,265,264 and U.S. Pat. No. 4,249,554 describe emulsions which have an oil content of only 50%; this means that under these conditions, half of the volume available (for example of a pipeline) is not available for transporting oil.

Canadian patents 1,108,205; 1,113,529; 1,117,568 and U.S. Pat. No. 4,246,919, on the other hand indicate rather limited decreases in viscosity, in spite of the presence of a low oil content.

U.S. Pat. No. 4,770,199 describes the use of emulsifying agents consisting of complex mixtures of non-ionic alkoxylated surface-active agents and ethoxylated-propoxylated carboxylates. The non-ionic surface-active agent of this mixture is obviously sensitive to temperature and may consequently become insoluble in water under certain temperature conditions, inverting the phases, i.e. from O/W to W/O. The phase inversion may also be caused by high shear values during the moving operation.

The above surface-active agents, moreover, are extremely expensive and contribute to considerably increasing the process costs.

Finally, again in the field of O/W emulsions, EP-A-237,724 describes the use of mixtures of ethoxylated carboxylates and ethoxylated sulfates, products which are not easily available on the market.

Contrary to these documents, WO-94/01684 solves the problem of moving heavy crude oils by the formation of O/W dispersions obtained with the help of dispersing agents injected into the oil wells. With respect to the usual surface-active agents, the dispersing agents are sulfonates which are extremely soluble in water and do not greatly reduce the surface tension of the water.

All these documents however do not disclose the moving of refinery tar (a material which is very different from heavy crude oils) by means of the formation of O/W dispersions.

A process has now been found which allows a more qualified use of refinery tar.

In accordance with this, the present invention relates to a process for recovering and moving refinery tar by means of the formation of oil in water dispersions of the above tar, the above dispersions having a water content of at least 20% by weight, preferably greater than 25% by weight, even more preferably from 28% to 32% by weight, and the dispersing agent being selected from salts of alkaline metals and ammonium, and relative mixtures, of condensates of naphthalenesulfonic acid with formaldehyde, which comprises:

a) fluidification of the tar by heating to a temperature at least equal to its softening point;

b) mixing the tar thus fluidified with the desired quantity of water and dispersing agent until a dispersion of oil in water is formed;

c) recovery and moving of the tar in the form of the dispersion of oil in water formed in step (b).

With respect to the dispersing agents, these are particular additives with the following characteristics in which they differ from the usual surface-active agents: high solubility in water (normally at 20° C. over 15% by weight); limited lowering of the surface tension in water (usually at a concentration of 1% in water, the surface tension decreases by a maximum of 10%). From a chemical point of view, the dispersing agents which can be used in the process of the present invention are alkaline or ammonium salts of polymeric sulfonates deriving from the condensation of naphthalenesulfonic acid with formaldehyde.

As far as the dispersing agents are concerned, these are products or mixtures of products which promote the formation of a dispersion, or stabilize a dispersion, without significantly altering the interface tension between water and oil.

In the process of the present invention, the term “dispersion” refers to a multiphase system, in which one phase is continuous and at least another if finely dispersed. In the dispersions formed according to the process of the present invention, the continuous phase is water, whereas the dispersed phase, more or less finely distributed, consists of particles, either solid or liquid, of refinery tar. The dispersing agents promote and stabilize the dispersions thus formed. As can be noted in the experimental part, the sulfonates of earth-alkaline metals are not effective, but only the sulfonates of alkaline metals and ammonium, preferably sodium.

Step (a) of the process of the present invention consists in fluidifying the tar, usually by heating to at least its softening point.

Once fluidified,. the tar is put in contact with water and the dispersing agent, preferably with an aqueous solution of dispersing agent. The weight ratio between tar and water can vary within a wide range, for example between 90/10 and 10/90. It is preferable, however, for obvious economic reasons, to use other tar contents, which may however cause the drawback of an excessive viscosity.

The quantity of dispersing agent also depends on the type of tar to be moved; in any case, the quantity of dispersing agent necessary for having a stable, fluid dispersion ranges from 0.05 to 2.5% by weight, preferably from 0.3 to 1.5% by weight, said percentages referring to the quantity of dispersing agent with respect to the total quantity of water and oil tar.

The contact between tar and aqueous solution of the dispersing agent can be carried out, either batchwise or in continuous, directly in the plant in which the tar is formed, or in any storage place of the above tar.

The contact between aqueous solution of the dispersing agent and tar can be facilitated by stirring devices, such as stirrers, centrifugal pumps and turbines. Once the dispersion has been formed (this can be easily confirmed by observing the decrease in the viscosity of the system), it can be easily transported by pumping to the storage sites or for end use (for example directly in combustion).

The following examples provide a better understanding of the present invention.

### EXAMPLES

The quantities of distilled water (FW) and additive calculated in relation to the type of dispersion to be produced, are accurately weighed in a glass container. The additive, soluble in water, is homogenized by simple mechanical stirring.

The weighed quantity of tar, preheated in a water bath or oven to 80-130° C., is added to the aqueous solution. The glass container, containing the aqueous solution of additive as lower phase and the oil as upper phase, is heated in a water bath to the pre-selected preparation temperature of the dispersion (40-95° C.).

When the desired temperature has been reached, the mixture is subjected to mechanical stirring (Ultraturrax UT45 type, equipped with a simple turbine at a constant rate of 10,000 rpm) for the desired time (2 or 5 minutes): the Ultraturrax turbine is positioned, for activation, in the aqueous phase.

The dispersion produced is left to rest for about 24 hours and analyzed in terms of viscosity at 25° C. The above viscosity measurements are effected using an RFSII rheometer, with a couette geometry, of Rheometrics.

The following tables, under the item viscosity, indicate two values, both, MPa and 24 hours after the start of the preparation of the dispersion, the first corresponding to 10 sec⁻¹, the second to 100 sec⁻¹.

The stability of the aqueous solutions is determined by calculating the water separated over a period of time with respect to the total dispersion. The tables indicate the stability as a measurement of the percentage of water separated after 27 days with respect to the total weight of the dispersion.

With respect to the dispersing agents used, the symbol R5 relates to Rheobuild® 5000 of M.A.C., i.e. sodium naphthalene sulphonic acid condensed with formaldehyde having a molecular weight of 4,304; the symbol Rl relates to Rheobuild® 1,000 of M.A.C., i.e. calcium naphthalene sulphonic acid condensed with formaldehyde having a molecular weight of 3,390; the symbol D4 relates to NNMSH 40 OF Great to an ethoxylated nonylphenol having a molar ratio between ethylene. oxide and nonyl phenol of 5.18.

Table 1 indicates the tests effected using visbreaking tar initialed 6B2 VSB charge RA 673 having the following characteristics: Fe 53 mg/kg, Na 16 mg/kg, Ni 70 mg/kg, V 238 mg/kg; RCC: 16.2 w/w %, S: 2.71 w/w %.

Table 2 on the other hand. indicates the tests carried out using a vacuum residue initialed SZRN/02 having the following characteristics: Fe 73 mg/kg, Na 25 mg/kg, Ni 129 mg/kg, V 390 mg/kg; RCC: 29.0 w/w %, S: 3.62 w/w %.

Finally, Table 3 indicates the tests effected using a visbreaking tar initialed ATZ RV, having the following characteristics: Fe 49 mg/kg, Na 23 mg/kg, Ni 81 mg/kg, V 236 mg/kg; RCC: 28.3 w/w %, S: 4.38 w/w %.

In the above tables, the viscosity is expressed in MPa. The first datum refers to the viscosity at 10 sec⁻¹, the second datum to the viscosity at 100 sec−1. The stability is expressed in % of water separated after 27 days of rest.

TABLE 1

| | | | w % | | | | |
|---|---|---|---|---|---|---|---|
| Ex. | Add. | w % H₂O | Add. | Temp./Time | Viscosity | | Stability |
| 1 | R5 | 30.25 | .97 | 78-80/2 | 189 | 134 | 7.8 |
| 2 | R5 | 29.73 | 1.89 | 80-81/2 | 197 | 170 | n.d. |
| 3 | R5 | 29.53 | .48 | 78-79/2 | 247 | 159 | 5.7 |
| 4 | R5 | 30.32 | .51 | 43-46/2 | 91 | 60 | 15.6 |
| 5 | R5 | 30.69 | .98 | 44-46/2 | 662 | 261 | 13.6 |
| 6 | R5 | 30.55 | 1.96 | 43-45/2 | 176 | 79 | traces |
| 7 | R5 | 30.45 | 1.93 | 80-81/5 | 254 | 158 | traces |
| 8 | D4 | 30.52 | .97 | 76-78/2 | 183 | 106 | 11.2 |
| 9 | D4 | 30.18 | 1.92 | 78-79/2 | 304 | 106 | 10.8 |
| 10 | D4 | 30.38 | .52 | 78-79/2 | 153 | 113 | 8.7 |
| 11 | D4 | 30.26 | .50 | 42-45/2 | 157 | 66 | n.d. |
| 12 | D4 | 30.39 | .97 | 42-47/2 | 174 | 82 | 18 |
| 13 | D4 | 30.42 | 1.97 | 44-49/2 | 260 | 107 | 20 |
| 14 | D4 | 29.96 | 1.90 | 80-83/5 | 336 | 129 | 13.6 |
| 15C | R1 | 29.29 | .93 | 80-81/2 | n.m. | n.m. | unv. |
| 16C | R1 | 30.38 | 1.93 | 80-82/2 | n.m. | n.m. | unv. |
| 17C | Et | 29.67 | .31 | 40-42/ | n.m. | n.m. | — |

TABLE 2

| | | | w % | Temp. ° C./ | Viscosity | | |
|---|---|---|---|---|---|---|---|
| Ex. | Add. | w % H₂O | Add. | Time min. | MPa | | Stability |
| 18 | R5 | 29.74 | .49 | 90-93/5 | — | — | — |
| 19 | R5 | 30.38 | 1.00 | 92-95/5 | 84 | 53 | 15-18 |
| 20 | R5 | 29.96 | 1.92 | 94-95/5 | 111 | 62 | 15-18 |
| 21 | D4 | 30.20 | .51 | 91-93/5 | 71 | 62 | 6-8 |
| 22 | D4 | 30.56 | .99 | 91-94/5 | 79 | 51 | 15-18 |
| 23 | D4 | 30.37 | 1.97 | 89-92/5 | 134 | 63 | 6-8 |
| 24C | R1 | 43.40 | 1.41 | 91-92/5 | n.d. | n.d. | separated |

TABLE 3

| | | | | | Viscosity | | |
|---|---|---|---|---|---|---|---|
| Ex. | Add. | w % H₂O | w % Add. | Temp./Time | (MPa) | | Stability |
| 25 | R5 | 30.24 | .50 | 93-98/5 | 79 | 70 | 8-10 |
| 26 | R5 | 30.14 | 1.01 | 94-96/5 | 101 | 70 | 8-10 |
| 27 | R5 | 30.32 | 1.94 | 93-95/5 | 115 | 71 | 4-6 |
| 28 | D4 | 29.62 | .50 | 94-95/5 | 91 | 70 | 14-16 |
| 29 | D4 | 30.44 | 1.01 | 94-95/5 | 111 | 60 | 4-6 |
| 30 | D4 | 29.71 | 1.92 | 90-92/5 | 193 | 81 | traces |

1. A process for recovering and moving refinery tar by the formation of oil in water dispersions of the above tar, the above dispersions having a water content of at least 20% by weight, and the dispersing agent being selected from salts of alkaline metals and ammonium, and relative mixtures, of the condensates of naphthalenesulfonic acid with formaldehyde, which comprises:
a) fluidification of the tar by heating to a temperature at least equal to its softening point;
b) mixing the tar thus fluidified with the desired quantity of water and dispersing agent until a dispersion of oil in water is formed;
c) recovery and moving of the tar in the form of the oil in water dispersion formed in step (b).

2. The process according to claim 1, characterized in that the water content of the dispersion is greater than 25% by weight.

3. The process according to claim 2, characterized in that the water content of -the dispersion ranges from 28% to 32% by weight.

4. The process according to claim 1, characterized in that. the dispersing agent is selected from salts of alkaline metals of the condensates of naphthalenesulfonic acid with formaldehyde.

5. The process according to claim 4, characterized in that the dispersing agent is selected from sodium salts of the condensates of naphthalenesulfonic acid with formaldehyde.
